(19) United States
(12) Patent Application Publication
(10) Pub. No.: US 2025/0285017 A1
(43) Pub. Date: Sep. 11, 2025

(54) SAFERL WITH INTEGRATED INTERVENTION POLICY

(71) Applicant: Samsung Display Co., Ltd., Yongin-si (KR)

(72) Inventors: Shuhui Qu, Fremont, CA (US); Janghwan Lee, Pleasanton, CA (US); Kasra Yazdani, San Jose, CA (US)

(21) Appl. No.: 18/930,282

(22) Filed: Oct. 29, 2024

Related U.S. Application Data
(60) Provisional application No. 63/563,187, filed on Mar. 8, 2024.

(51) Int. Cl. G06N 20/00; G06Q 10/1093; G06Q 50/04

(52) U.S. Cl. CPC G06N 20/00; G06Q 10/1093; G06Q 50/04

(57) ABSTRACT

A method includes operating a machine-learning agent with a learning policy; assigning a risk level for each intervention event of an intervention policy during the operating of the machine-learning agent with the learning policy; offline learning of a state-action value function defining a risk of intervention of the intervention policy for each state-action pair; generating an integrated policy by combining the learning policy with the state-action value function; operating the machine-learning agent with the integrated policy; and updating the state-action value function and the learning policy based on intervention of the intervention policy; and outputting the learning policy after the updating.

### CROSS-REFERENCE TO RELATED APPLICATION(S)

The present application claims priority to and the benefit of U.S. Provisional Application No. 63/563,187 filed Mar. 8, 2024, the entire content of which is incorporated herein by reference.

### BACKGROUND

### 1. Field

The present disclosure relates to reinforcement learning techniques.

### 2. Description of the Related Art

Modern manufacturing facilities frequently produce a diverse range of products (e.g., hundreds of thousands of product lots), with each undergoing numerous processes across multiple machines. Accordingly, jobs are competing for resources, such as machines, masks, etc. Efficiently coordinating among these machines to achieve higher productivity and utilization presents a challenge.

Some related art scheduling methods utilize one or more human operators. However, human-based scheduling requires extensive domain expertise and years of training to generate reasonable schedules.

Some related art methods utilize reinforcement learning (RL)-based scheduling techniques. Reinforcement learning is a machine learning technique in which an artificial intelligence-based agent takes actions in a dynamic environment through trial-and-error methods to maximize the collective rewards based on the feedback generated based on the actions taken by the agent. Factories typically employ a set of evaluation criteria to assess schedule quality given by a particular scheduling policy in which the quality is determined by calculating the weighted sum of these criteria. However, enumerating all safety considerations during modeling is not always feasible, and experts or schedulers may intervene during production when the deployed policy might lead to harmful results (i.e., an intervention policy and/or human intervention may be forced to intervene to prioritize safety and ensure the selected actions are safe). That is, the use of related art RL-based scheduling techniques may lead to unsafe or risky behaviors as the agent explores and tries actions that could have negative consequences, particularly in situations where the consequences of actions are not well-understood or in situations where exploring is costly or dangerous. The invention policy/human intervention, if applied independently, may degrade the performance of the optimal scheduling policy.

Additionally, some related art scheduling methods may utilize a constrained Markov decision process (CMDP), but these methods do not guarantee safety during the training phase of the agent, the iterative methods employed can be challenging to scale effectively, convergence issues may arise during the training process, and smoothness and ergodicity of the CMDP are required. Moreover, some related art methods utilize domain-specific heuristic rules, but the agent cannot inherently learn to be safe and avoid violating these heuristic rules during execution.

The above information disclosed in this Background section is only for enhancement of understanding of the background of the invention and therefore it may contain information that does not constitute prior art.

### SUMMARY

The present disclosure relates to various methods. In one embodiment, the method includes operating a machine-learning agent with a learning policy; assigning a risk level for each intervention event of an intervention policy during the operating of the 1 machine-learning agent with the learning policy; offline learning of a state-action value function defining a risk of intervention of the intervention policy for each state-action pair; iteratively, until convergence, for each episode: generating an integrated policy by combining the learning policy with the state-action value function; operating the machine-learning agent with the integrated policy; and updating the state-action value function and the learning policy based on intervention of the intervention policy; and outputting the learning policy after the updating.

Operating the machine-learning agent with the learning policy may be in a manufacturing facility including machines and the learning policy may determine an order of operating the machines, and the method may further include scheduling, by the machine-learning agent operating with the learning policy, the order of operating the machines at the manufacturing facility.

The method may also include generating an integrated policy by combining the learning policy with the state-action value function; operating the machine-learning agent with the integrated policy; and updating the state-action value function and the learning policy based on intervention of the intervention policy. These tasks may be performed iteratively, until convergence, for each of a number of episodes, and outputting the learning policy.

The method may include scheduling jobs, based on the learning policy, at a manufacturing facility producing a number of product types with a number of machines and a number of masks.

For each product type of the number of product types, a state of each state-action pair may be a job queue length, a waiting time of a first job, or an urgency of each of the jobs.

For each mask of the number of masks, a state of each state-action pair may be a number of available masks.

Operating the machine-learning agent with the integrated policy may include collecting (state, action, reward, next state) and (state, action, risk level, next state) tuples.

The intervention policy may include a rule to process jobs having a longest waiting queue first.

The intervention policy may include a rule to process jobs having a waiting time exceeding a threshold wait time first.

The intervention policy may include a rule to process jobs in a first-in-first-out

(FIFO) manner.

The method may also include scheduling jobs at a manufacturing facility based on the learning policy.

The risk level may be 1 for a high risk or 0.1 for a low risk.

The present disclosure also relates to various embodiments of a method of scheduling jobs at a manufacturing facility producing a number of product types with a number of machines and a number of masks. In one embodiment, the method includes operating a machine-learning agent with a learning policy; assigning a risk level for each intervention event of an intervention policy during the operating of the machine-learning agent with the learning policy; offline learning of a state-action value function defining a risk of intervention of the intervention policy for each state-action pair; iteratively, until convergence, for each of a number of episodes: generating an integrated policy by combining the learning policy with the state-action value function; operating the machine-learning agent with the integrated policy; and updating the state-action value function and the learning policy based on intervention of the intervention policy; outputting the learning policy; and scheduling the jobs, by the machine-learning agent operating with the learning policy, of the manufacturing facility.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable method or system.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1 is a schematic view of a device configured to schedule operations in a manufacturing facility for manufacturing a product according to one embodiment of the present disclosure;

FIG. 2 is a schematic view of a reinforcement learning system for governing the scheduling of operations of a manufacturing facility according to one embodiment of the present disclosure;

FIG. 3 is a flowchart illustrating tasks of a method of generating a reinforcement learning policy with an integrated intervention policy;

FIG. 4 is a schematic view depicting the manufacturing of a set of products processed by different machines according to a predetermined processing sequence; and

FIG. 5 is a flowchart illustrating tasks of a method of scheduling jobs at a manufacturing facility producing a plurality of product types with a plurality of machines according to one embodiment of the present disclosure.

### DETAILED DESCRIPTION

The present disclosure relates to various methods for training a machine-learning agent to develop a policy for scheduling manufacturing processes that mitigates the risk of unintended consequences, unsafe behavior, catastrophic failure and/or harmful actions during the training phase (i.e., when the machine-learning agent explores its environment). The present disclosure also relates to the integration of an intervention policy, which is a set of rules or actions taken to prevent the machine-learning agent from taking certain actions that may lead to unsafe and/or undesirable outcomes, without excessively reducing the performance of the machine-learning agent (i.e., the integration of the intervention policy is configured to promote safety while maintaining high performance of the machine-learning agent). While the disclosure is described with respect to policies for scheduling manufacturing processes, the improvements described herein may be utilized in any system that uses policies to determine an order of operations, such as other robotic control applications, navigation systems, autonomous driving applications, and large language model training.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

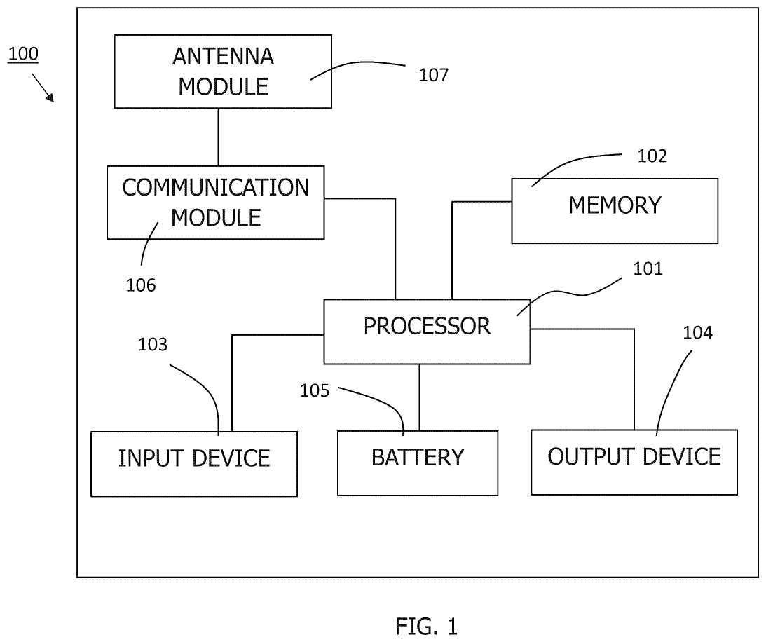

FIG. 1 is a schematic view of an electronic device 100 configured to schedule the order of operations of various machines (e.g., deposition stations) in a manufacturing facility for manufacturing one or more products, such as display devices. In the illustrated embodiment, the electronic device 100 includes a processor 101, a non-volatile memory device 102 (e.g., flash memory, ferroelectric random-access memory (F-RAM), magnetostrictive RAM (MRAM), FeFET memory, and/or resistive RAM (ReRAM) memory) connected to the processor 101, and an input device 103 and an output device 104 connected to the processor 101 and/or the memory device 102, a battery 105 connected to the processor 101 and the non-volatile memory device 102, a communication module 106, and an antenna module 107. The battery 105 may supply power to at least one component of the electronic device 100. The battery 105 may include, for example, a primary cell which is not rechargeable, a secondary cell which is rechargeable, or a fuel cell. In one or more embodiments, at least one of the components may be omitted from the electronic device 100 and/or one or more other components may be added to the electronic device 100.

The input device 103 may receive a command or data to be used by another component (e.g., the processor 101) of the electronic device 100, from the outside (e.g., a user) of the electronic device 100. The input device 103 may include, for example, a microphone, a mouse, or a keyboard. The input device 103 is configured to accept or receive information regarding one or more parameters regarding the machines and/or the products being produced in the manufacturing facility (e.g., state information about the machines in the manufacturing facility, such as, for each type of product produced at the manufacturing facility, a job queue length, a waiting time for a first job, a tightness of a waiting queue, and/or an urgency of each job type).

The output device 104 is configured to output the scheduling order of the machines for producing the one or more products (e.g., machine 4 first, then machine 2, then machine 7, etc.). The output device 104 may be a screen, such as an LED display device. In one or more embodiments, the input device 103 and the output device 104 may be a combined or integrated as an input-output (I/O) device. The output device 140 may visually provide information to the outside (e.g., a user) of the electronic device 100. The output device 104 may include, for example, a display, a hologram device, or a projector and control circuitry to control a corresponding one of the display, hologram device, and projector. The output device 104 may include touch circuitry adapted to detect a touch, or sensor circuitry (e.g., a pressure sensor) adapted to measure the intensity of force incurred by the touch.

A program may be stored in the memory 102 as software, and may include, for example, an operating system (OS), middleware, or an application. The processor 101 may execute the program to control at least one other component (e.g., a hardware or a software component) of the electronic device 100 coupled with the processor 101 and may perform various data processing or computations. As at least part of the data processing or computations, the processor 101 may load a command or data received from another component (e.g., the input device 103) in volatile memory, process the command or the data stored in the volatile memory, and store resulting data in non-volatile memory device 102. In one or more embodiments, the non-volatile memory device 102 stores artificial intelligence (e.g., a reinforcement learning algorithm), which, when executed by the processor 101, is configured to receive the state information about the machines and/or the products being produced in the manufacturing facility from the input device 103, learn and set the scheduling order of the machines, and then output the scheduling order on the output device 104.

The term “processor” is used herein to include any combination of hardware, firmware, and software, employed to process data or digital signals. The hardware of a processor may include, for example, application specific integrated circuits (ASICs), general purpose or special purpose central processors (CPUs), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors; for example, a processor may include two processors, an FPGA and a CPU, interconnected on a PWB. The processor 101 may include a main processor (e.g., a central processing unit (CPU) or an application processor (AP)), and an auxiliary processor (e.g., a graphics processing unit (GPU), an image signal processor (ISP), a sensor hub processor, or a communication processor (CP)) that is operable independently from, or in conjunction with, the main processor. Additionally or alternatively, the auxiliary processor may be adapted to consume less power than the main processor, or execute a particular function. The auxiliary processor may be implemented as being separate from, or a part of, the main processor.

The auxiliary processor may control at least some of the functions or states related to at least one component (e.g., the output device 104) among the components of the electronic device, instead of the main processor while the main processor is in an inactive (e.g., sleep) state, or together with the main processor while the main processor is in an active state (e.g., executing an application). The auxiliary processor (e.g., an image signal processor or a communication processor) may be implemented as part of another component functionally related to the auxiliary processor.

The communication module 106 may be configured to support establishing a direct (e.g., wired) communication channel or a wireless communication channel between the electronic device 100 and an external electronic device (e.g., another electronic device or a server) and performing communication via the established communication channel. The communication module 106 may include one or more communication processors that are operable independently from the processor 101 (e.g., the AP) and supports a direct (e.g., wired) communication or a wireless communication. The communication module 106 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device or a server via a short-range communication network (e.g., BLUETOOTH™, wireless-fidelity (Wi-Fi) direct, or a standard of the Infrared Data Association (IrDA)) or a long-range communication network (e.g., a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The communication module 106 may identify and authenticate the electronic device 100 in a communication network, such as the short-range communication network or the long-range communication network, using subscriber information (e.g., international mobile subscriber identity (IMSI)) stored in a subscriber identification module.

The antenna module 107 may transmit or receive a signal or power to or from the outside (e.g., an external electronic device) of the electronic device 10. The antenna module 107 may include one or more antennas, and, therefrom, at least one antenna appropriate for a communication scheme used in the communication network, such as the long-range or the short-range communication network, may be selected, for example, by the communication module 106. The signal or the power may then be transmitted or received between the communication module 106 and the external electronic device via the selected at least one antenna.

Commands or data may be transmitted or received between the electronic device 100 and an external electronic device via a server coupled with a long-range communication network. Each of the electronic devices may be a device of a same type as, or a different type, from the electronic device 100. All or some of operations to be executed at the electronic device 100 may be executed at one or more of the external electronic devices. For example, if the electronic device 100 should perform a function or a service automatically, or in response to a request from a user or another device, the electronic device 100, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 100. The electronic device 100 may provide the outcome, with or without further processing of the outcome, as at least part of a reply to the request. To that end, a cloud computing, distributed computing, or client-server computing technology may be used, for example.

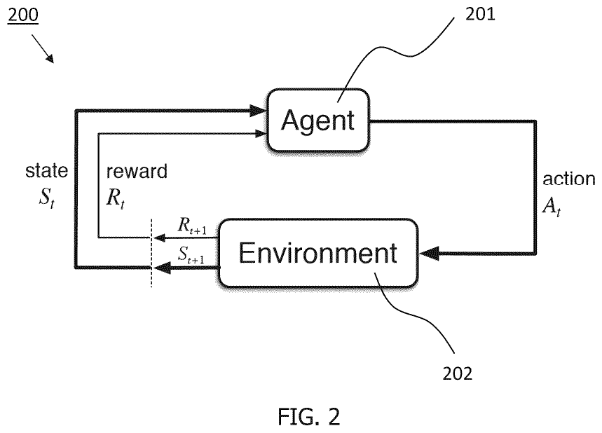

FIG. 2 is a reinforcement learning (RL) system 200 for governing the scheduling of operations a plurality of hardware and/or software such as operations for processing data or operations of machines in a manufacturing facility. For ease of explanation, FIG. 1 is described with respect to operations of machines in a manufacturing facility according to one embodiment of the present disclosure, but the same methods may be applied to any system which determines an order of operations for a plurality of components. In the illustrated embodiment, the RL system 200 includes a machine-learning agent 201 connected to environment 202 (e.g., the machines of the manufacturing facility). The machine-learning agent 201 may be stored in the memory device 102 of the device 100 of FIG. 1. The machine-learning agent 201 is configured to take an action a at time-step t (e.g., the machine-learning agent 201 is configured to cause the machines of the manufacturing facility to take a certain action a). In response, the environment 202 is configured to switch from state s into state s′, and an immediate reward Ra(s, s′) is generated after transitioning from state s to s′ under action a. In one or more embodiments in which the environment 202 is a manufacturing facility producing a plurality of products, the state S may include, for each type of product produced at the manufacturing facility, a job queue length, a waiting time for a first job, a tightness of a waiting queue, or an urgency of each job type. In one or more embodiments, the state S may include, for each mask, a number of available masks.

Reinforcement learning is modeled as a Markov decision process (MDP) <S, A, R, P, γ>, where S is a set of environment and agent states, A is a set of actions of the machine-learning agent 201, P is the probability that the environment 202 will transition from state s to state s′ under action a of the set of actions A performed by the agent 201, Rₐ(s, s′), the immediate reward after the environment 202 transitions from state s to state s′under action a, and γ (where γ∈[0,1]) is the discounted factor, which determines whether the focus is on immediate rewards (γ=0), the total reward (γ=1), or a balance thereof (0<γ<1). The state S of the environment 202 may be either a safe state (S_{safe}⊂S) or an unsafe state (S_{unsafe}⊂S). In one or more embodiments, the agent 201 is operating under a policy π that is configured to achieve a high cumulative return (i.e., the sum of all rewards R that the machine-learning agent 201 expects to receive when following the policy from the state to the end of the episode) with a minimum probability P of entering unsafe states (i.e., max_{π}V^{π}(s₀) such that (1−γ)Σₜ₌₀P(sₜ∈S_{safe}|π)≥1−δ and V̅^{π}(s₀)≤δ, where δ is the threshold probability, VT is the reward value function for the policy π (i.e., <S, A, R, P, γ> Reward MDP), and IT is the risk value function for the policy π (i.e., <S, A, C, P, γ> Cost MDP). That is, V is the expected long-term return of the current state s under policy π.

In one or more embodiments, the RL system 200 is configured to achieve (e.g., guarantee) a desired performance while also operating safely (e.g., reducing or minimizing the likelihood of the intervention policy intervening). For instance, in one or more embodiments, the RL system 200 operates such that

$${V}^{π *} ( {s}_{0} ) - {V}^{{π}^{′}} ( {s}_{0} ) \leq \frac{2}{1 - γ} P ( {π}^{*} ) + ϵ and {\overline{V}}^{{π}^{′}} ( {s}_{0} ) \leq {\overline{V}}^{μ} ( {s}_{0} ) + ϵ ,$$

where V^{π}*(s₀) is the reward value function for the state s₀ under policy π*, V^{π′}(s₀) is the reward value function for the state so under policy π′, P(π*) is the probability that the invention policy intervenes when operating under the policy π*, V̅^{π′} is the risk value function for the state so under integrated policy π′, V̅^{μ}(s₀) is the risk value function for the state so under the intervention policy u, and e is the greedy algorithm that defines the balance between exploration and exploitation. The asterisk (*) denotes the desired or optimal value of the relevant parameter.

FIG. 2 is a flowchart illustrating tasks of a method 300 of generating a reinforcement learning policy with an integrated intervention policy according to one embodiment of the present disclosure. In the illustrated embodiment, the method 300 includes, for each of a plurality of episodes (1 . . . n), a task 310 of rolling out the trajectory of the machine-learning agent with a policy π_{θ} (e.g., a random policy) until the intervention policy μ_{1, . . . , K} intervenes or a max time limit is reached. That is, during the rollout, the state S may be either a safe state (S_{safe}⊂S) or an unsafe state (S_{unsafe}⊂S). If an unsafe state (s∈S_{unsafe}) is encountered, the intervention policy μ_{1, . . . , K} will be executed until the safe state (s∈S_{safe}) is reached again under different possible conditions. In one or more embodiments, the intervention policy μ_{1, . . . , K} is a set of rules or actions that can be taken to intervene and prevent the machine-learning agent from taking actions that may lead to unsafe or undesirable outcomes. In this manner, the intervention policy μ_{1, . . . , K} is configured to mitigate these risks and ensure that the actions taken by the machine-learning agent adhere to these predefined safety constraints. In one or more embodiments, the intervention policy μ_{1, . . . , K} may include a set of rules related to the production of products in a manufacturing facility, such as processing jobs for which the waiting queue is longest first, processing jobs for which the waiting timing exceeds a threshold waiting time first, or processing the jobs in a first-in-first-out (FIFO) manner.

Additionally, in the illustrated embodiment, the method also includes a task 320, for each intervention of the intervention policy μ_{1, . . . , K}, of marking the intervention signal of the intervention policy μ_{1, . . . , K}, with the associated risk level rᵢₙₜₑᵣᵥₑₙₑ (e.g., the task 320 including recording the state s, action a, risk rᵢₙₜₑᵣᵥₑₙₑ, next state s′). That is, each time of intervention of the intervention policy μ_{1, . . . , K} during the training of the agent is marked or tagged with a corresponding risk level. The risk level is the risk of intervention of each intervention policy μ_{1, . . . , K}. For instance, in one or more embodiments, the task 320 includes marking the intervention signal with rᵢₙₜₑᵣᵥₑₙₑ=1 in response to the intervention policy μ_{1, . . . , K} indicating a high risk or marking the intervention signal with rᵢₙₜₑᵣᵥₑₙₑ=0.1 in response to the intervention policy μ_{1, . . . , K} indicating a low risk.

In the illustrated embodiment, the method 300 also includes a task 330 of performing offline learning to learn a state-action value function Q_{safe} (i.e., the quality function) as a risk value table, which defines a risk of intervention of the intervention policy μ_{1, . . . , K}, for each state-action pair (s,a). Given (s, a, rᵢₙₜₑᵣᵥₑₙₑ, s′, a′), Q_{safe}(s, a)=r+γQ_{safe}(s′, a′), and given (s, a, rᵢₙₜₑᵣᵥₑₙₑ, s′, Done), Q_{safe}(s, a)=r+γmax_{a′}Q_{safe}(s′, a′), where r is the risk of intervention of the intervention policy μ_{1, . . . , K} and γ is the discounted factor (where γ∈[0,1]). In offline learning, the agent learns from a pre-recorded dataset (i.e., the policy training is decoupled from the data collection process), whereas in online learning the agent interacts with the environment. In one or more embodiments, the risk level rᵢₙₜₑᵣᵥₑₙₑ may be sparse and the method 300 may include decomposing the risk level rᵢₙₜₑᵣᵥₑₙₑ with an exponential decay function or other inverse reinforcement learning (IRL) process. In this manner, tasks 310, 320, and 330 are configured to enable safe data collection.

In the illustrated embodiment, the method 300 also includes a task 340 of initializing the policy π_{θ} and a task 350 of generating the integrated policy π′, which is a combination of the policy to be learned It and state-action value function Q_{safe} (i.e., the risk table learned in task 330) that is configured to achieve both safety and performance. In one or more embodiments, the integrated policy π′ is defined as follows: π′(a|s)=π(s, a) [symbol] {(s, a)∈τ}+E[μ(a|s)](1−Σ_{ã:(s,ã)∉τ}π(ã|s)), where τ is the safe action set defined as follows: τ={(s, a)∈S_{safe}×a:Q_{safe}(s, a)<η}, where n is the learning rate.

In the illustrated embodiment, the method 300 also includes a task 360 of rolling out the trajectory of the agent with the integrated policy π′ until the intervention policy μ_{1, . . . , K} intervenes or a max time limit is reached. Task 360 also includes collecting data as (state s, action a, reward R, next state s′) and (state s, action a, risk level r, next state s′) tuples.

Additionally, in the illustrated embodiment, the method 300 includes a task 370 of updating the state-action value function Q_{safe} and the learnt policy π based on the intervention of the intervention policy μ_{1, . . . , K} in task 360.

In one or more embodiments, the method 300 includes repeatedly performing tasks 340-370 until convergence is achieved. Following convergence, the method 300 includes a task 380 of generating or outputting the desired or optimal policy π_{θ}* and the desired or optimal state-action value function Q_{safe}*. The asterisk (*) denotes the desired or optimal value of the relevant parameter. The learned policy π output in task 380 may then be utilized to schedule jobs or tasks in a manufacturing facility that produces a plurality of products with a plurality of machines and processes.

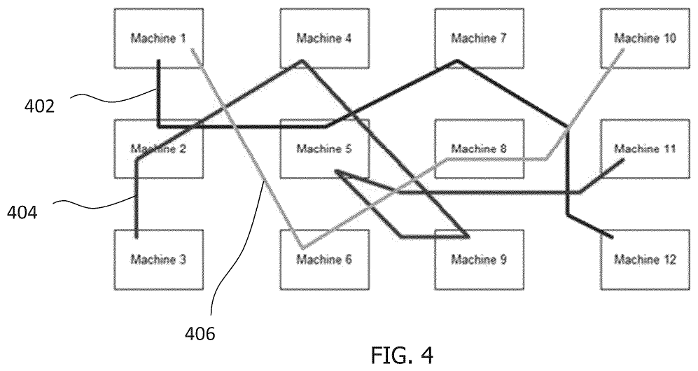

FIG. 4 depicts the manufacturing of a set of products processed by different machines according to the learned policy π. Machines 1-12 may comprise different manufacturing machines being operated according to a learned policy π. For example, a computing system may execute the reinforcement learning model described herein to determine an order by which Machines 1-12 operate. The solid lines in FIG. 4 indicate an order by which the machines are determined to operate based on the learned policy π. For example, the learned policy π output in task 380 may indicate a scheduling order 402 in which a job should be processed first by Machine 1, then by Machine 2, then by Machine 5, then Machine 7, and finally by Machine 12. In another example, the learned policy π output in task 380 may indicate a scheduling order 404 in which a job should be processed first by Machine 3, then by Machine 2, then by Machine 4, then Machine 9, then by Machine 5, and finally by Machine 11. In another example 406, the learned policy π output in task 380 may indicate a scheduling order in which a job should be processed first by Machine 1, then by Machine 6, then by Machine 8, and finally by Machine 10. The jobs scheduled utilizing the learned policy it output in task 380 may be deposition jobs utilizing deposition hard masks.

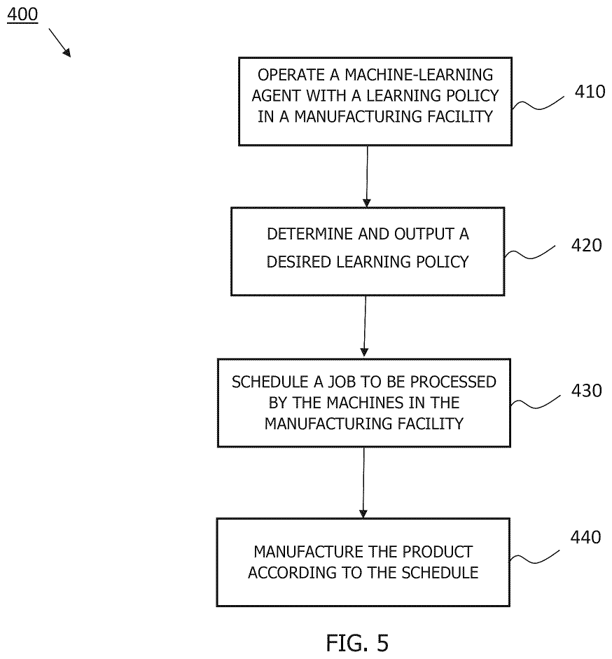

FIG. 5 is a flowchart illustrating tasks of a method 400 of scheduling jobs at a manufacturing facility producing a plurality of product types with a plurality of machines (e.g., a plurality of deposition machines including a plurality of masks, as illustrated in FIGS. 4A-4B). In the illustrated embodiment, the method 400 includes a task 410 of operating a machine-learning agent with a learning policy. The machine-learning agent may be stored in the memory 102 of the device 100 of FIG. 1 in a manufacturing facility.

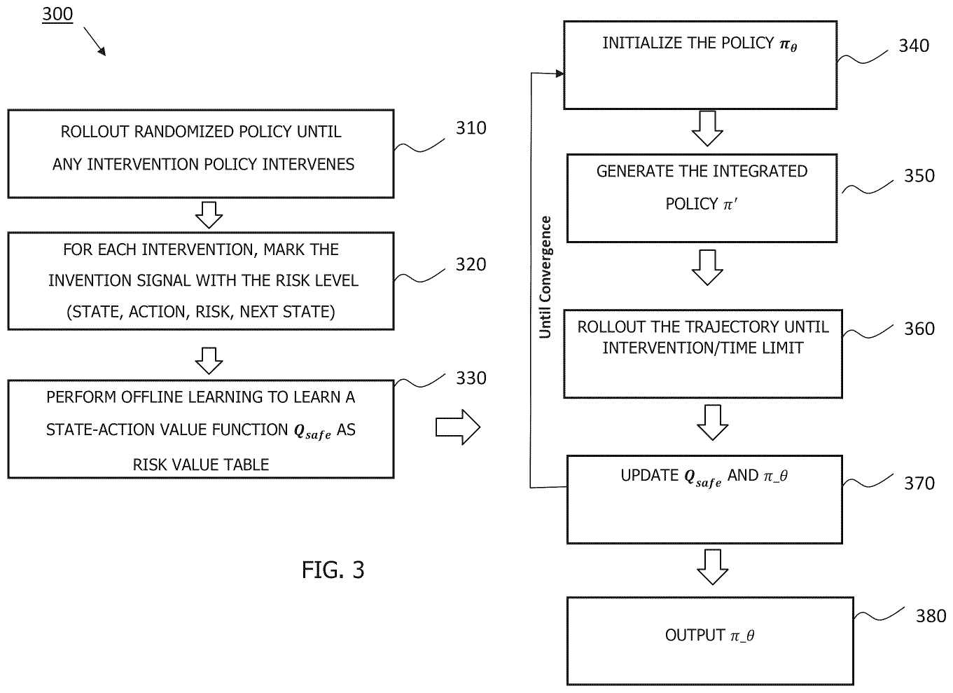

In the illustrated embodiment, the method 400 also includes a task 420 of determining and outputting a desired or optimal learning policy. The task 420 of determining and outputting the desired or optimal learning policy may include the tasks 310-380 described above with reference to the method 300 illustrated in FIG. 3.

In the illustrated embodiment, the method 400 also includes a task 430 scheduling the jobs, by the machine-learning agent operating with the learning policy, of the manufacturing facility. For instance, as illustrated in FIG. 4A, the task 430 may include scheduling a job to be processed first by Machine 1, then by Machine 2, then by Machine 5, then Machine 7, and finally by Machine 12. the task 430 may include scheduling a job to be processed first by Machine 1, then by Machine 2, then by Machine 5, then Machine 7, and finally by Machine 12. In one or more embodiments, the task 430 may include scheduling a job to be processed first by Machine 3, then by Machine 2, then by Machine 4, then Machine 9, then by Machine 5, and finally by Machine 11. In one or more embodiments, the task 430 may include scheduling a job to be processed first by Machine 1, then by Machine 6, then by Machine 8, and finally by Machine 10. The jobs scheduled in task 430 may be deposition jobs utilizing deposition hard masks, or any other jobs performed during the manufacturing of a display device or any other device. For instance, FIG. 4B depicts a queue of products waiting to be processed by a first deposition station utilizing a first hard mask and a second deposition station utilizing a second hard mask, and the task 430 may include scheduling the order in which the products are deposited utilizing the first and second deposition stations.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
operating a machine-learning agent with a learning policy;
assigning a risk level for each intervention event of an intervention policy during the operating of the machine-learning agent with the learning policy;
offline learning of a state-action value function defining a risk of intervention of the intervention policy for each state-action pair;
iteratively, until convergence, for each of a plurality of episodes:
generating an integrated policy by combining the learning policy with the state-action value function;
operating the machine-learning agent with the integrated policy; and
updating the state-action value function and the learning policy based on intervention of the intervention policy; and
outputting the learning policy after the updating.

2. The method of claim 1, wherein the operating of the machine-learning agent with the learning policy is in a manufacturing facility comprising a plurality of machines and the learning policy determines an order of operating the plurality of machines, and
wherein the method further comprises scheduling, by the machine-learning agent operating with the learning policy, the order of operating the plurality of machines at the manufacturing facility.

3. The method of claim 2, wherein, for each product type of a plurality of product types produced by the plurality of machines, a state of each state-action pair is selected from the group consisting of a job queue length, a waiting time of a first job, and an urgency of each of the jobs.

4. The method of claim 3, wherein the plurality of machines comprises a plurality of masks, and wherein for each mask of the plurality of masks, a state of each state-action pair is a number of available masks.

5. The method of claim 1, wherein the operating the machine-learning agent with the integrated policy comprises collecting (state, action, reward, next state) and (state, action, risk level, next state) tuples.

6. The method of claim 1, wherein the intervention policy comprises a rule to process jobs having a longest waiting queue first.

7. The method of claim 1, wherein the intervention policy comprises a rule to process jobs having a waiting time exceeding a threshold wait time first.

8. The method of claim 1, wherein the intervention policy comprises a rule to process jobs in a first-in-first-out (FIFO) manner.

9. The method of claim 1, wherein the risk level is 1 for a high risk.

10. The method of claim 1, wherein the risk level is 0.1 for a low risk.

11. A system configured to schedule an order of operating a plurality of machines at a manufacturing facility, the system comprising:
one or more processors;
a non-volatile memory device storing instructions which, when executed by the one or more processors, cause the system to:
operate a machine-learning agent with a learning policy in the manufacturing facility;
assign a risk level for each intervention event of an intervention policy during the operating of the machine-learning agent with the learning policy;
offline learning of a state-action value function defining a risk of intervention of the intervention policy for each state-action pair;
iteratively, until convergence, for each of a plurality of episodes:
generate an integrated policy by combining the learning policy with the state-action value function;
operate the machine-learning agent with the integrated policy; and
update the state-action value function and the learning policy based on intervention of the intervention policy; and
output the learning policy after the updating, the learning policy determining the order of operating the plurality of machines.

12. The system of claim 11, wherein the instructions, when executed by the one or more processors, further cause the system to schedule, by the machine-learning agent operating with the learning policy, the order of operating the plurality of machines at the manufacturing facility.

13. The system of claim 12, further comprising an input device configured to accept or receive information regarding one or more parameters regarding the plurality of machines and/or products being produced in the manufacturing facility.

14. The system of claim 12, further comprising an output device configured to output the order of operating the plurality of machines.

15. The system of claim 12, wherein, for each product type of a plurality of product types produced by the plurality of machines, a state of each state-action pair is selected from the group consisting of a job queue length, a waiting time of a first job, and an urgency of each of the jobs.

16. The system of claim 15, wherein the plurality of machines comprises a plurality of masks, and wherein for each mask of the plurality of masks, a state of each state-action pair is a number of available masks.

17. The system of claim 12, wherein the instructions, when executed by the one or more processors, further cause the system to collect (state, action, reward, next state) and (state, action, risk level, next state) tuples.

18. The system of claim 12, wherein the intervention policy comprises a rule to process jobs having a longest waiting queue first.

19. The system of claim 12, wherein the intervention policy comprises a rule to process jobs having a waiting time exceeding a threshold wait time first.

20. The system of claim 12, wherein the intervention policy comprises a rule to process jobs in a first-in-first-out (FIFO) manner.
